(19) United States
(12) Patent Application Publication
(10) Pub. No.: US 2004/0138354 A1
(43) Pub. Date: Jul. 15, 2004

(54) Stabiliser combination for halogen-containing polymers and the use thereof

(75) Inventors: Stefan Fokken, Biberbach (DE); Walther Reith, Egenhofen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Baerlocher GmbH

(21) Appl. No.: 10/682,951

(22) Filed: Oct. 10, 2003

Related U.S. Application Data
(63) Continuation of application No. PCT/EP02/03638, filed on Apr. 2, 2002.

(30) Foreign Application Priority Data
Apr. 11, 2001 (DE) 101 18 179.5

(51) Int. Cl. C09K 15/00

(52) U.S. Cl. 524/241; 252/397; 524/247

(57) ABSTRACT

The present invention is a stabiliser combination, comprising at least one amino alcohol, at least one halogen-containing salt of an oxy acid and at least one compound having a structural element of the general formula I

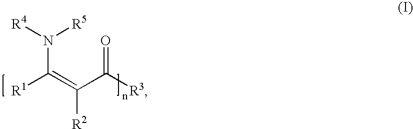

and polymer compositions stabilised therewith.

### CROSS-REFERENCE TO RELATED APPLICATIONS

This is a continuation application of PCT/EP02/03638, filed Apr. 2, 2002, which is incorporated herein by reference in its entirety, and also claims the benefit of German Priority Application No. 101 18 179.5, filed Apr. 11, 2001.

### FIELD OF THE INVENTION

The present invention relates to a stabiliser combination, comprising an amino alcohol, at least one halogen-containing salt of an oxy acid and at least one compound having a structural element of the general formula I

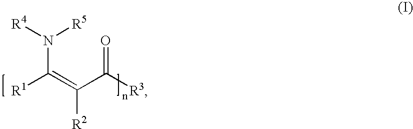

and polymer compositions stabilised therewith.

### BACKGROUND OF THE INVENTION

It is known that halogen-containing plastics have a tendency to undergo undesirable decomposition and breakdown reactions under thermal stress during processing or during long-term use. The breakdown of halogenated polymers, especially in the case of PVC, results in the formation of hydrochloric acid, which is eliminated from the polymer strand, resulting in a discoloured, unsaturated plastics having colour-imparting polyene sequences.

A particular problem in that case is that halogen-containing polymers exhibit the rheological conditions necessary for processing only at a relatively high temperature. At such temperatures, however, in the case of unstabilised polymers the polymer already begins to undergo significant decomposition, which results both in the undesirable colour change described above and in a change in the material properties. Furthermore, the hydrochloric acid freed from non-stabilised, halogen-containing polymers at such a processing temperature can lead to significant corrosion of the processing apparatus. That process plays a particular role when, during the processing of such halogenated polymers to form moulded articles, for example by extrusion, production is interrupted and the polymer mass remains in the extruder for a prolonged period. During that period the above-mentioned decomposition reactions may occur, so that the charge in the extruder is rendered unusable and the extruder may possibly be damaged.

In addition to the problems described herein, which occur in an early phase of the production of moulded articles from halogen-containing polymers, factors important to the in-use properties of such a moulded article over a prolonged period include, however, colour stability and as far as possible unchanged material properties. Especially in the case of moulded articles that are exposed to light, fluctuating temperatures, water or other external influences caused by weathering, as the period of use increases changes occur to the colour and the material properties which at the very least have an adverse effect on the aesthetic appearance of the moulded article, but also may eventually lead to the moulded article's becoming unusable. In particular, a combination of irradiation with high-energy radiation and thermal stress, as frequently occurs in the outer region of moulded articles during use, often leads to the moulded article's undergoing undesirable changes.

According to the teaching of EP-B 0 424 572, partial replacement of titanium dioxide by zinc sulfide brings about an improvement in the weathering stability of lead- and cadmium-stabilised PVC-U moulded articles. The use of such a stabiliser combination increases the heavy metal content of the moulded article, however, which is undesirable from environmental standpoints.

In order to counteract the problem of thermally induced and radiation-induced changes in the properties of moulded articles made of halogen-containing polymers, more recently Ca/Zn stabiliser systems, for example, have been used for white PVC mouldings. Such stabiliser systems are not sufficiently effective, however, as regards stabilisation in respect of thermostability and weathering stability.

The use of OH-group-containing isocyanurates together with calcium hydroxide or calcium oxide is described, for example, in WO 99/55777.

Although the stabiliser compositions known from the prior art frequently do exhibit satisfactory properties in respect of initial colour and colour stability under thermal stress, while other stabiliser compositions known from the prior art exhibit good properties in respect of stabilisation in the event of combined stress caused by high-energy radiation and heat, the compositions known hitherto were in need of improvement in terms of a combination of both kinds of stress.

SUMMARY OF THE INVENTION

The object of the present invention is therefore to provide a stabiliser composition which, as a constituent of halogen-containing polymers, provides both excellent initial colour and colour stability. Furthermore, it is an object of the invention that the stabiliser composition should offer, in respect of the use of moulded articles produced from a polymer composition so stabilised, excellent colour stability in the outer region under thermal stress and stress caused by high-energy radiation.

These objects of the invention are provided by a stabiliser composition and by a polymer composition comprising such a stabiliser composition, as described hereinbelow.

The present invention therefore relates to a stabiliser composition, at least comprising an amino alcohol and at least one halogen-containing salt of an oxy acid and at least one compound having a structural element of the general formula I

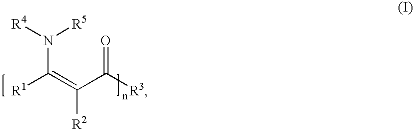

wherein n is a number from 1 to 100,000, the radicals R⁴, R⁵, R¹ and R² are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR⁴ or CH₂C(O), or the radical R³ is so linked to the radical R¹ that in total an unsubstituted or substituted, saturated or unsaturated heterocyclic ring system having from 4 to 24 carbon atoms is formed, or a mixture of two or more of the mentioned compounds.

### DETAILED DESCRIPTION OF THE PREFERRED EMBODIMENTS

A “stabiliser composition” is to be understood in the context of the present invention as being a composition that can be used for the stabilisation of halogen-containing polymers. For achieving that stabilisation effect, a stabiliser composition according to the invention is generally mixed with a halogen-containing polymer to be stabilised and then processed. It is equally possible, however, for a stabiliser composition according to the invention to be mixed with the halogen-containing polymer to be stabilised during processing.

A stabiliser composition according to the invention has at least three constituents. As a first constituent a composition according to the invention comprises at least one amino alcohol.

Suitable amino alcohols in the context of the present invention are in principle any compounds having at least one OH group and a primary, secondary or tertiary amino group or a combination of two or more of the mentioned amino groups. In principle, in the context of the present invention both solid and liquid amino alcohols are suitable as a constituent of the stabiliser compositions according to the invention. In the context of the present invention, however, the content of liquid amino alcohols is, for example, so chosen that the entire stabiliser composition is substantially in solid form.

Within the scope of a further preferred embodiment of the present invention, a stabiliser composition according to the invention contains a maximum of approximately 5% by weight of liquid amino alcohol or a mixture of two or more liquid amino alcohols, but preferably the content is lower, for example 1% by weight or less. Within the scope of an especially preferred embodiment of the present invention, a stabiliser composition according to the invention contains no liquid amino alcohols.

Amino alcohols suitable for use in the context of the present invention have, within the scope of a preferred embodiment of the present invention, a melting point higher than approximately 30° C., especially higher than approximately 50° C. Suitable amino alcohols are, for example, mono- or poly-hydroxy compounds which are based on linear or branched, saturated or unsaturated aliphatic mono- or poly-amines.

There are suitable in this connection, for example, OH-group-carrying derivatives of primary mono- or poly-amino compounds having from 2 up to about 40, for example from 6 up to about 20, carbon atoms. Examples thereof are corresponding OH-group-carrying derivatives of ethylamine, n-propylamine, isopropylamine, n-propylamine, sec-propylamine, tert-butylamine, 1-aminoisobutane, substituted amines having from 2 to about 20 carbon atoms, such as 2-(N,N-dimethylamino)-1-aminoethane. Suitable OH-group-carrying derivatives of diamines are, for example, those based on diamines having a molecular weight of from approximately 32 to approximately 200 g/mol, the corresponding diamines having at least two primary, two secondary, or one primary and one secondary amino group(s). Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2,2,2]octane, 1-azabicyclo[3,3,0]octane, N,N,N′,N′-tetramethylethylenediamine, N,N,N′,N′-tetramethylbutanediamine, N,N,N′,N′-tetramethyl-1,6-hexanediamine, pentamethyldiethylenetriamine, tetramethyldiaminoethyl ether, bis(dimethylaminopropyl)urea, N,N′-dimethylpiperazine, 1,2-dimethylimidazole and di(4-N,N-dimethylaminocyclohexyl)methane.

Especially suitable are aliphatic amino alcohols having from 2 to about 40, preferably from 6 to about 20, carbon atoms, for example 1-amino-3,3-dimethyl-pentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having from 6 to about 20 carbon atoms, there coming into consideration as aromatic structures heterocyclic or isocyclic ring systems such as naphthalene or especially benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures of two or more such compounds.

Within the scope of an especially preferred embodiment of the present invention, the amino alcohols used are heterocyclic compounds having a cyclic ring system containing amino groups, the OH groups being bonded to the ring either directly or preferably by way of spacers.

Within the scope of an especially preferred embodiment of the present invention there are used heterocyclic amino alcohols having at least 2, preferably at least 3, amino groups in the ring. As central ring component of the amino alcohols suitable for use according to the invention there are especially suitable the trimerisation products of isocyanates.

Special preference is given to hydroxyl-group-containing isocyanurates of the general formula II

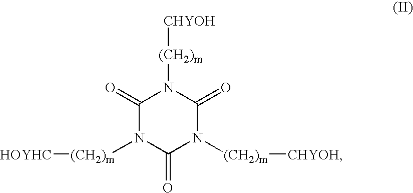

wherein the groups Y and the indices m are identical or different and m is an integer from 0 to 20 and Y is a hydrogen atom or a linear or branched, saturated or unsaturated alkyl group having from 1 to about 10 carbon atoms. In the context of the present invention special preference is given to the use of tris(hydroxymethyl)isocyanurate (THEIC) as constituent of the stabiliser compositions according to the invention.

A stabiliser composition according to the invention may, for example, contain only one amino alcohol. In the context of the present invention, however, a stabiliser composition according to the invention can equally comprise a mixture of two or more different amino alcohols.

The total content of amino alcohol or amino alcohols in a stabiliser composition according to the invention is preferably at least approximately 0.1% by weight. The upper limit for the content of amino alcohol or amino alcohols in a stabiliser composition according to the invention is approximately 99.9% by weight, but preferably the upper limit is lower, for example at approximately 80% by weight or less, for example approximately 70, 50 or 30% by weight. When a stabiliser composition according to the invention comprises more than two components, the content of amino alcohol or amino alcohols may also be, for example, in a range of from approximately 0.5 to approximately 25% by weight, for example from approximately 1 to approximately 20 or from approximately 3 to approximately 15 or from approximately 5 to approximately 10% by weight.

In addition to an amino alcohol or a mixture of two or more amino alcohols, as already explained hereinbefore, a stabiliser composition according to the invention also contains at least two further compounds.

As at least one further compound there are suitable halogen-containing salts of oxy acids, especially the perchlorates. Examples of suitable perchlorates are those of the general formula M(ClO₄)ₖ, wherein M is Li, Na, K, Mg, Ca, Sr, Zn, Al, La or Ce. The index k, according to the valency of M, is the number 1, 2 or 3. The mentioned perchlorate salts can be complexed with alcohols (polyols, cyclodextrins) or ether alcohols or ester alcohols. Ester alcohols also include the polyol partial esters. Suitable polyvalent alcohols or polyols include their dimers, trimers, oligomers and polymers, such as di-, tri-, tetra- and poly-glycols, and also di-, tri- and tetra-pentaerythritol or polyvinyl alcohol in various degrees of polymerisation and hydrolysis. As polyol partial esters preference is given to glycerol monoethers and glycerol monothioethers. Sugar alcohols or thio sugars are also suitable.

The perchlorate salts can be used in various common delivery forms, for example in the form of a salt or an aqueous solution supported on a suitable carrier material, such as PVC, calcium silicate, zeolites or hydrotalcites, or bonded by chemical reaction into a hydrotalcite. A combination of sodium perchlorate and calcium silicate that is suitable as a constituent of the stabiliser composition according to the invention can be obtained, for example, by combining an aqueous solution of sodium perchlorate (content of sodium perchlorate about 60% or more) with calcium silicate, for example with a synthetic, amorphous calcium silicate. Suitable particle sizes for the calcium silicate suitable for use are, for example, from approximately 0.1 to approximately 50 μm, for example from approximately 1 to approximately 20 μm. Suitable perchlorate-containing delivery forms are described, for example, in U.S. Pat. No. 5,034,443, reference being expressly made to the perchlorate-containing delivery forms disclosed therein and that disclosure being regarded as part of the disclosure of this text.

Further suitable delivery forms are mentioned, for example, in EP-A 394,547, EP-A 457,471 and WO 94/24200, reference being expressly made to the suitable delivery forms disclosed therein and that disclosure being regarded as part of the disclosure of this text.

In the context of the present invention, a stabiliser composition according to the invention can comprise an appropriate salt of a halogen-containing oxy acid in an amount of from approximately 0.1 to approximately 50% by weight, for example from approximately 1 to approximately 35% by weight, especially from approximately 10 to approximately 20% by weight, in each case in dependence upon the delivery form. Based on the content of anions of the halogen-containing oxy acid, for example based on the content of perchlorate anions, the content of salts of a halogen-containing oxy acid in the stabiliser composition is, for example, from approximately 0.01 to approximately 20% by weight, especially from approximately 1 to approximately 10% by weight.

In addition to an amino alcohol or a mixture of two or more amino alcohols, as already described hereinbefore, and a halogen-containing salt of an oxy acid, a stabiliser composition according to the invention also contains at least one compound having a structural element in accordance with the general formula I

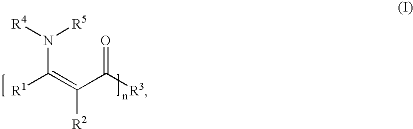

wherein n is a number from 1 to 100,000, the radicals R⁴, R⁵, R¹ and R² are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR⁴ or CH₂C(O), or the radical R³ is so linked to the radical R¹ that in total an unsubstituted or substituted, saturated or unsaturated heterocyclic ring system having from 4 to 24 carbon atoms is formed, or a mixture of two or more compounds having a structural element in accordance with the general formula I.

Within the scope of a preferred embodiment of the present invention, as the compound of the general formula I there is used a compound based on an α,β-unsaturated β-aminocarboxylic acid, especially a compound based on β-aminocrotonic acid. Especially suitable are the esters or thioesters of corresponding aminocarboxylic acids with monovalent or polyvalent alcohols or mercaptans wherein X in each of the mentioned cases is O or S.

When the radical R³ together with X is an alcohol or mercaptan radical, such a radical can be formed, for example, from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, 1,3-butanediol, 1,4-butanediol, 1,6-hexanediol, 1,10-decanediol, diethylene glycol, thio-diethanol, trimethylolpropane, glycerol, tris(2-hydroxymethyl) isocyanurate, triethanolamine, pentaerythritol, di-trimethylolpropane, diglycerol, sorbitol, mannitol, xylitol, di-pentaerythritol and also the corresponding mercapto derivatives of the mentioned alcohols.

Within the scope of an especially preferred embodiment of the present invention, as the compound having a structural element in accordance with the general formula I there is used a compound in which R¹ is a linear alkyl radical having from 1 to 4 carbon atoms, R² is hydrogen and R³ is a linear or branched, saturated, mono- to hexa-valent alkyl or alkylene radical having from 2 to 12 carbon atoms or a linear, branched or cyclic 2- to 6-valent ether alcohol radical or thioether alcohol radical.

Suitable compounds having a structural element in accordance with the general formula I include, for example, β-aminocrotonic acid stearyl ester, 1,4-butanediol di(β-aminocrotonic acid) ester, thio-diethanol-β-aminocrotonic acid ester, trimethylolpropane tri-β-aminocrotonic acid ester, pentaerythritol-tetra-β-aminocrotonic acid ester, dipentaerythritol-hexa-β-aminocrotonic acid ester and the like. The mentioned compounds can be present in a stabiliser composition according to the invention alone or as a mixture of two or more thereof.

Compounds that are likewise suitable as compounds having a structural element in accordance with the general formula I in the context of the present invention are aminouracil compounds of the general formula III

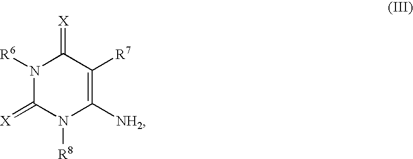

wherein the radicals R⁶ and R⁷ have the meanings already given above and the radical R⁸ is hydrogen, an unsubstituted or substituted linear or branched, saturated or unsaturated aliphatic hydrocarbon radical having from 1 to 44 carbon atoms, an unsubstituted or substituted saturated or unsaturated cycloaliphatic hydrocarbon radical having from 6 to 44 carbon atoms or an unsubstituted or substituted aromatic hydrocarbon radical having from 6 to 44 carbon atoms.

The compound according to formula III thus falls within the scope of the compounds according to formula I wherein n in the general formula I is 1 and the radicals R¹ and R³ according to the general formula I are linked to form the structural element of the general formula IV

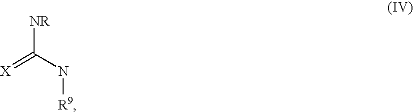

wherein X is S or O. R¹ in the case of a compound of the general formula IV is therefore N—R⁹, while R³ is —RN—C═X and the two radicals are covalently linked by way of a N—C bond to form a heterocyclic ring.

In the context of the present invention it is preferable to use compounds of the general formula IV wherein R⁹ is hydrogen.

Within the scope of a further preferred embodiment of the present invention, in the stabiliser compositions according to the invention there are used compounds of the general formula III wherein R⁶ and R⁸ are a linear or branched alkyl radical having from 1 to 6 carbon atoms, for example methyl, ethyl, propyl, butyl, pentyl or hexyl, an OH-group-substituted linear or branched alkyl radical having from 1 to 6 carbon atoms, for example hydroxymethyl, hydroxyethyl, hydroxypropyl, hydroxybutyl, hydroxypentyl or hydroxyhexyl, an aralkyl radical having from 7 to 9 carbon atoms, for example benzyl, phenylethyl, phenylpropyl, dimethylbenzyl or phenylisopropyl, it being possible for the mentioned aralkyl radicals to be substituted, for example, by halogen, hydroxy or methoxy, or an alkenyl radical having from 3 to 6 carbon atoms, for example vinyl, alkyl, methallyl, 1-butenyl or 1-hexenyl.

Within the scope of a preferred embodiment of the present invention, in the stabiliser compositions according to the invention there are used compounds having a structural element in accordance with the general formula III wherein R⁶ and R⁸ are hydrogen, methyl, ethyl, n-propyl, isopropyl, n-, iso-, sec- or tert-butyl.

Also suitable as compounds of the general formula I are, for example, compounds in which the radicals R¹ and R² are linked to form an aromatic or heteroaromatic system, for example aminobenzoic acid, aminosalicylic acid or aminopyridinecarboxylic acid and suitable derivatives thereof.

Within the scope of a preferred embodiment of the present invention, a stabiliser composition according to the invention comprises a compound having a structural element in accordance with the general formula I or a mixture of two or more compounds having a structural element in accordance with the general formula I, for example a compound of the general formula III, in an amount of from approximately 0.1 to approximately 99.5% by weight, especially from approximately 5 to approximately 50% by weight or from approximately 5 to approximately 25% by weight.

A stabiliser composition according to the invention may comprise an amino alcohol or a mixture of two or more amino alcohols and a salt of a halogen-containing oxy acid or a mixture of two or more salts of halogen-containing oxy acids and a compound having a structural element of the general formula I or a mixture of two or more such compounds.

It is preferred when the content of amino alcohol or amino alcohols in the stabiliser composition according to the invention is at least approximately 30% by weight, but preferably more, for example at least approximately 40 or at least approximately 50% by weight. The upper limit for the content of amino alcohol or amino alcohols in such cases is approximately 99% by weight. The content of a salt of a halogen-containing oxy acid or a mixture of two or more such salts is in this case from approximately 20 to approximately 50% by weight, the content of compounds having a structural element in accordance with the general formula I is in that case likewise from approximately 20 to approximately 50% by weight.

In addition to the above-mentioned constituents, a stabiliser composition according to the invention may comprise further additives.

Suitable additives in the context of the present invention are, for example, compounds having at least one mercapto-functional sp²-hybridised carbon atom. Compounds having at least one mercapto-functional sp²-hybridised carbon atom are to be understood in the context of the present invention as being in principle any compounds having a structural element Z═CZ—SH or a structural element Z₂C═S, it being possible for the two structural elements to be tautomeric forms of a single compound. The sp²-hybridised carbon atom may be a constituent of an unsubstituted or substituted aliphatic compound or a constituent of an aromatic system. Suitable types of compound are, for example, thiocarbamic acid derivatives, thiocarbamates, thiocarboxylic acids, thiobenzoic acid derivatives, thioacetone derivatives and thiourea or thiourea derivatives. Suitable compounds having at least one mercapto-functional, sp²-hybridised carbon atom are mentioned, for example, in the non-prior-published German patent application having the file reference 101 09 366.7.

Within the scope of a preferred embodiment of the present invention, thiourea or a thiourea derivative is used as the compound having at least one mercapto-functional, sp²-hybridised carbon atom.

Examples of additives also suitable for the stabiliser compositions according to the invention are carbazole or carbazole derivatives or mixtures of two or more thereof.

Further suitable additives are, for example, 2,4-pyrrolidinedione or derivatives thereof, such as are mentioned, for example, in the non-prior-published German patent application having the file reference 101 09 366.7.

Also suitable as additives are, for example, epoxy compounds. Examples of such epoxy compounds are epoxidised soybean oil, epoxidised olive oil, epoxidised linseed oil, epoxidised castor oil, epoxidised groundnut oil, epoxidised maize oil, epoxidised cottonseed oil, and also glycidyl compounds.

Glycidyl compounds contain a glycidyl group that is bonded directly to a carbon, oxygen, nitrogen or sulfur atom. Glycidyl or methylglycidyl esters are obtainable by reaction of a compound having at least one carboxyl group in the molecule and epichlorohydrin or glycerol dichlorohydrin or methyl-epichlorohydrin. The reaction is advantageously carried out in the presence of bases.

As compounds having at least one carboxyl group in the molecule there can be used, for example, aliphatic carboxylic acids. Examples of such carboxylic acids are glutaric acid, adipic acid, pimelic acid, suberic acid, azelaic acid, sebacic acid or dimerised or trimerised linoleic acid, acrylic acid, methacrylic acid, caproic acid, caprylic acid, lauric acid, myristic acid, palmitic acid, stearic acid or pelargonic acid and also the mono- or poly-carboxylic acids mentioned hereinbelow. Also suitable are cycloaliphatic carboxylic acids, such as cyclohexanecarboxylic acid, tetrahydrophthalic acid, 4-methyltetrahydrophthalic acid, hexahydrophthalic acid, endomethylenetetrahydrophthalic acid or 4-methylhexahydrophthalic acid. Also suitable are aromatic carboxylic acids, such as benzoic acid, phthalic acid, isophthalic acid, trimellitic acid or pyromellitic acid.

Glycidyl ethers or methylglycidyl ethers can be obtained by reaction of a compound having at least one free alcoholic OH group or a phenolic OH group and a suitably substituted epichlorohydrin under alkaline conditions or in the presence of an acidic catalyst and subsequent alkali treatment. Ethers of this type are derived, for example, from acyclic alcohols, such as ethylene glycol, diethylene glycol or higher poly(oxyethylene) glycols, propane-1,2-diol or poly(oxypropylene) glycols, butane-1,4-diol, poly(oxytetramethylene) glycols, pentane-1,5-diol, hexane-1,6-diol, hexane-2,4,6-triol, glycerol, 1,1,1-trimethylolpropane, bis-trimethylolpropane, pentaerythritol, sorbitol, and also from polyepichlorohydrins, butanol, amyl alcohol, pentanol, and also from monofunctional alcohols, such as isooctanol, 2-ethylhexanol, isodecanol or technical alcohol mixtures, for example technical fatty alcohol mixtures.

Suitable ethers are also derived from cycloaliphatic alcohols, such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohexan-3-ene, or they have aromatic nuclei, such as N,N-bis(2-hydroxyethyl)aniline. Suitable epoxy compounds can also be derived from mononuclear phenols, for example from phenol, resorcinol or hydroquinone, or they are based on polynuclear phenols, such as bis(4-hydroxyphenyl)methane, 2,2-bis(4-hydroxyphenyl)propane, 2,2-bis(3,5-dibromo4-hydroxyphenyl)propane, 4,4′-dihydroxydiphenylsulfones, or on condensation products of phenol with formaldehyde, for example phenol novolaks, obtained under acidic conditions.

Further terminal epoxides suitable as additives in the context of the present invention are, for example, glycidyl-1-naphthyl ether, glycidyl-2-phenyl phenyl ether, 2-diphenylglycidyl ether, N-(2,3-epoxypropyl)phthalimide or 2,3-epoxypropyl-4-methoxyphenyl ether.

Also suitable are N-glycidyl compounds, such as are obtainable by dehydrochlorination of the reaction products of epichlorohydrin with amines containing at least one amino hydrogen atom. Such amines are, for example, aniline, N-methylaniline, toluidine, n-butylamine, bis(4-aminophenyl)methane, m-xylylenediamine or bis(4-methylaminophenyl)methane.

Likewise suitable are S-glycidyl compounds, for example di-S-glycidyl ether derivatives, that are derived from dithiols, such as ethane-1,2-dithiol or bis(4-mercaptomethylphenyl) ether.

Especially suitable epoxy compounds are described, for example, on pages 3 to 5 of EP-A 1 046 668, reference being expressly made to the disclosure contained therein, which is to be regarded as part of the disclosure of this text.

Also suitable as additives in the context of the present invention are 1,3-dicarbonyl compounds, especially the β-diketones and β-keto esters. Suitable in the context of the present invention are dicarbonyl compounds of the general formula R′C(O)CHR″—C(O)R′″, as described, for example, on page 5 of EP 1 046 668, to which reference is expressly made especially in respect of the radicals R′, R″ and R′″ and the disclosure of which is regarded as being part of the disclosure of this text. Especially suitable are, for example, acetyl acetone, butanoyl acetone, heptanoyl acetone, stearoyl acetone, palmitoyl acetone, lauroyl acetone, 7-tert-nonylthioheptanedione-2,4, benzoyl acetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetylnonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, diacetoacetic acid methyl, ethyl, butyl, 2-ethylhexyl, dodecyl or octadecyl ester and also propionyl or butyryl acetic acid esters having from 1 to 18 carbon atoms, and also stearoyl acetic acid ethyl, propyl, butyl, hexyl or octyl esters or polynuclear β-keto esters, as described in EP-A 433 230, to which reference is expressly made, or dehydracetic acid and also the zinc, magnesium or alkali salts thereof or the alkali, alkaline earth or zinc chelates of the mentioned compounds insofar as they exist.

1,3-Diketo compounds can be present in a stabiliser composition according to the invention in an amount of up to approximately 20% by weight, for example up to approximately 10% by weight.

Polyols are also suitable as additives in the context of the stabiliser composition according to the invention. Suitable polyols are, for example, pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxymethyl) isocyanurate, palatinite, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

The polyols suitable as additives can be present in a stabiliser composition according to the invention in an amount of up to approximately 30% by weight, for example up to approximately 10% by weight.

Also suitable as additives are, for example, sterically hindered amines, such as those mentioned on pages 7 to 27 of EP-A 1 046 668. Reference is expressly made to the sterically hindered amines disclosed therein, the compounds mentioned therein being regarded as part of the disclosure of this text.

The sterically hindered amines suitable as additives can be present in a stabiliser composition according to the invention in an amount of up to approximately 30% by weight, for example up to approximately 10% by weight.

Also suitable as additives in the stabiliser compositions according to the invention are hydrotalcites, zeolites and alkali alumocarbonates. Suitable hydrotalcites, zeolites and alkali alumocarbonates are described, for example, on pages 27 to 29 of EP-A 1 046 668, on pages 3, 5 and 7 of EP-A 256 872, on pages 2 and 3 of DE-C 41 06 411 and on pages 2 and 3 of DE-C 41 06 404. Reference is expressly made to those specifications, and their disclosure at the indicated places is regarded as being part of the disclosure of this text.

The hydrotalcites, zeolites and alkali alumocarbonates suitable as additives can be present in a stabiliser composition according to the invention in an amount of up to approximately 50% by weight, for example up to approximately 30% by weight.

Also suitable as additives in the context of the stabiliser compositions according to the invention are, for example, hydrocalumites of the general formula V

M²⁺₍₂₊ₓ₎Al³⁺_{(1+y)}(OH)_{(6+z)}A^{j}ₐ[Bᵣ]^{nl}_{b}*mH₂O (V),

wherein M is calcium, magnesium or zinc or a mixture of two or more thereof, A is a j-valent inorganic or organic acid anion, j is 1, 2 or 3, B is an inorganic or organic acid anion other than A, r is a whole number≧1 and, when is r>1, indicates the degree of polymerisation of the acid anion, and l is 1, 2, 3 or 4 and indicates the valency of the acid anion, where, for r=1, l is 2, 3 or 4 and, for r>1, l indicates the valency of the individual monomer units of the polyanion and is 1, 2, 3 or 4 and rl indicates the total valency of the polyanion, and the following rules apply to the parameters x, y, a, b, r, z, and j:

0≦x<0.6,

0≦y<0.4, and where either x=0 or y=0,

0<a<0.8/r and

z=1+2x+3y−ja−r/b.

Within the scope of a preferred embodiment of the present invention, as additives there are used compounds of the general formula V wherein M is calcium, which may be in admixture with magnesium or zinc or magnesium and zinc.

In the general formula V, A is an r-valent inorganic or organic acid anion, wherein r is 1, 2 or 3. Examples of acid anions present in the context of hydrocalumites suitable for use according to the invention are halide ions, SO₃²⁻, SO₄²⁻, S₂O₃²⁻, S₂O₄²⁻, HPO₃²⁻, PO₄³⁻, CO₃²⁻, alkyl and dialkyl phosphates, alkyl mercaptides and alkyl sulfonates, wherein the alkyl groups may be identical or different, straight-chain, branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyro-mellitate, maleate, tartrate, citrate and also anions of the isomeric forms of hydroxyphthalic acid or hydroxymesic acid. Within the scope of a preferred embodiment of the present invention, A is an inorganic acid anion, especially a halide ion, for example F⁻, Cl⁻ or Br⁻, preferably Cl⁻.

In the general formula V, B is an acid anion other than A. For the case where r in the general formula V is the number 1, the letter B denotes a l-valent inorganic or organic acid anion, wherein L is the number 2, 3 or 4. Examples of acid anions B present in the context of compounds of the general formula V suitable for use according to the invention are, for example, O²⁻, SO₃²⁻, SO₄²⁻, S₂O₃²⁻, S₂O₄²⁻, HPO₃²⁻, PO₄³⁻, CO₃²⁻, alkyl and dialkyl phosphates, alkyl mercaptides and alkyl sulfonates, wherein the alkyl groups may be identical or different, straight-chained or branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyromellitate, maleate, tartrate, citrate, and also anions of the isomeric forms of hydroxyphthalic acid or hydroxymesic acid. B in the context of the present invention in formula V is preferably a borate or an anion of an optionally functionalised di-, tri- or tetra-carboxylic acid. Special preference is given to carboxylic acid anions and anions of hydroxycarboxylic acids having at least two carboxyl groups, very special preference being given to citrates.

For the case where r in the general formula V is a number greater than 1, the term [Bᵣ]^{rl-} denotes an inorganic or organic polyanion having a degree of polymerisation r and the valency l of the individual monomer units of the polyanion with the total valency rl, wherein l is equal to or greater than 1. Examples of suitable polyanions [Bᵣ]^{rl-} are polyacrylates, polycarboxylates, polyborates, polysilicates, polyphosphates and polyphosphonates.

In all the above-mentioned cases, the acid anions A and B can be present in any desired ratio a/b in the compounds of the general formula V.

The compounds of the general formula V are not compounds having a layered structure of the hydrotalcite or hydrocalumite type but a physical mixture of M²⁺/aluminium oxide hydrates with salts of divalent metals. X-ray diffractograms of the compounds of the general formula V used in the composition according to the invention clearly show that they are not discrete crystalline compounds of a known type but mixtures that are amorphous to X-rays.

For the preparation of the compounds according to the general formula V, solutions or suspensions of oxidic forms of the desired cations (e.g. NaAlO₂, Ca(OH)₂, Zn(OH)₂, Al(OH)₃) can, following known procedures, be mixed with solutions or suspensions of salts or the corresponding acids of the desired anions and reacted at temperatures of from 40 to 95° C., it being possible for the reaction times to be varied between 15 and 300 minutes.

When surface-treatment of the reaction products is desired, the surface-treatment medium can be added directly to the reaction products and the product can be separated from the mother liquor by filtration and dried at suitable temperatures between 100 and 250° C. The added amount of surface-treatment medium is, for example, from approximately 1 to approximately 20% by weight.

In the context of the stabiliser compositions according to the invention, compounds of the general formula V can be used in an amount of up to approximately 50% by weight, for example up to approximately 30% by weight or up to approximately 15% by weight.

Within the scope of a further embodiment of the present invention, a stabiliser composition according to the invention comprises at least one basic calcium salt. Suitable basic calcium salts are, for example, calcium oxide, calcium hydroxide and calcium carbonate. The basic calcium salts may optionally have been surface-modified.

Also suitable as additives to the stabiliser composition according to the invention are metal oxides, metal hydroxides and metal soaps of saturated, unsaturated, straight-chain or branched, aromatic, cycloaliphatic or aliphatic carboxylic acids or hydroxycarboxylic acids having especially from about 2 to about 22 carbon atoms.

As metal cations, the metal oxides, metal hydroxides or metal soaps suitable as additives have especially a divalent cation; the cations of calcium or zinc or mixtures thereof are especially suitable, but within the scope of a preferred embodiment of the present invention the stabiliser compositions according to the invention are zinc-free.

Examples of suitable carboxylic acid anions include anions of monovalent carboxylic acids, such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid, sorbic acid, anions of divalent carboxylic acids or monoesters thereof, such as oxalic acid, malonic acid, maleic acid, tartaric acid, cinnamic acid, mandelic acid, malic acid, glycolic acid, oxalic acid, salicylic acid, polyglycoldicarboxylic acids having a degree of polymerisation of from approximately 10 to approximately 12, phthalic acid, isophthalic acid, terephthalic acid or hydroxyphthalic acid, anions of tri- or tetra-valent carboxylic acids or mono-, di- or tri-esters thereof, as in hemimellitic acid, trimellitic acid, pyromellitic acid or citric acid, and also so-called overbased carboxylates as described, for example, in DE-A 41 06 404 or DE-A 40 02 988, the disclosure of the last-mentioned documents being regarded as part of the disclosure of this text.

Within the scope of a preferred embodiment of the present invention, it is preferable to use metal soaps having anions derived from saturated or unsaturated carboxylic acids or hydroxycarboxylic acids having from about 8 to about 20 carbon atoms. Special preference is given to stearates, oleates, laurates, palmitates, behenates, versatates, hydroxystearates, dihydroxystearates, p-tert-butyl benzoates or (iso)octanoates of calcium or zinc or mixtures of two or more thereof. Within the scope of a further preferred embodiment of the present invention, a stabiliser composition according to the invention has calcium stearate or zinc stearate or a mixture thereof.

A stabiliser composition according to the invention can comprise the mentioned metal oxides, metal hydroxides or metal soaps, or a mixture of two or more thereof, in an amount of up to approximately 50% by weight, for example in an amount of up to approximately 30% by weight.

A stabiliser composition according to the invention can furthermore comprise as thermostabiliser component an organotin compound or a mixture of two or more organotin compounds. Suitable organotin compounds are, for example, methyltin-tris(isooctyl-thioglycolate), methyltin-tris(isooctyl-3-mercaptopropionate), methyltin-tris(isodecyl-thioglycolate), dimethyltin-bis(isooctyl-thioglycolate), dibutyltin-bis(isooctyl-thioglycolate), monobutyltin-tris(isooctyl-thioglycolate), dioctyltin-bis(isooctyl-thioglycolate), monooctyltin-tris(isooctyl-thioglycolate) or dimethyltin-bis(2-ethylhexyl-β-mercaptopropionate).

Furthermore, in the context of the stabiliser compositions according to the invention it is possible to use the organotin compounds which are mentioned and the preparation of which is described on pages 18 to 29 of EP-A 0 742 259. Reference is expressly made to the above-mentioned disclosure, the compounds mentioned therein and their preparation being understood as being part of the disclosure of this text.

A stabiliser composition according to the invention can comprise the described organotin compounds in an amount of up to approximately 20% by weight, especially up to approximately 10% by weight.

Within the scope of a further embodiment of the present invention, a stabiliser composition according to the invention can comprise organic phosphite esters having from 1 to 3 organic radicals, two or more of which radicals may be identical or all of which may be different. Suitable organic radicals are, for example, linear or branched, saturated or unsaturated alkyl radicals having from 1 to 24 carbon atoms, unsubstituted or substituted alkyl radicals having from 6 to 20 carbon atoms or unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyldicresyl, octyl-di(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl) phosphite or tristearyl sorbitol-triphosphite or mixtures of two or more thereof.

A stabiliser composition according to the invention can comprise the described phosphite compounds in an amount of up to approximately 30% by weight, especially up to approximately 10% by weight.

A stabiliser composition according to the invention can also comprise as additives blocked mercaptans, as mentioned on pages 4 to 18 of EP-A 0 742 259. Reference is expressly made to the disclosure in the specification indicated, which is understood as being part of the disclosure of this text.

A stabiliser composition according to the invention can comprise the described blocked mercaptans in an amount of up to approximately 30% by weight, especially up to approximately 10% by weight.

A stabiliser composition according to the invention can also comprise lubricants, such as paraffin waxes, polyethylene waxes, polypropylene waxes, montan waxes, ester lubricants, such as fatty acid esters, purified or hydrogenated natural or synthetic triglycerides or partial esters, amide waxes, chloroparaffins, glycerol esters or alkaline earth soaps. Lubricants suitable for use are also described in “Kunststoffadditive”, R. Gächter/H. Müller, Carl Hanser Verlag, 3rd edition, 1989, pages 478-488. Also suitable as lubricants are, for example, fatty ketones, as described in DE 4,204,887, and also silicone-based lubricants, as mentioned, for example, in EP-A 0 259 783, or combinations thereof, as mentioned in EP-A 0 259 783. Reference is expressly made to the mentioned documents, the disclosure of which relating to lubricants is to be regarded as being part of the disclosure of this text. Especially suitable in the context of the present invention are lubricants of the product range Baerolub® from Baerlocher GmbH (Unter-schleiβheim, Germany).

A stabiliser composition according to the invention can comprise the described lubricants in an amount of up to approximately 70% by weight, especially up to approximately 40% by weight.

Also suitable as additives for stabiliser compositions according to the present invention are organic plasticisers.

Suitable as plasticisers are, for example, compounds from the group of phthalic acid esters, such as dimethyl, diethyl, dibutyl, dihexyl, di-2-ethylhexyl, di-n-octyl, diisooctyl, diisononyl, diisodecyl, dicyclohexyl, dimethylcyclohexyl, dimethyl glycol, dibutyl glycol, benzylbutyl or diphenyl phthalate and also mixtures of phthalates, for example mixtures of alkyl phthalates having from 7 to 9 or 9 to 11 carbon atoms in the ester alcohol or mixtures of alkyl phthalates having from 6 to 10 and 8 to 10 carbon atoms in the ester alcohol. Especially suitable in the sense of the present invention are dibutyl, dihexyl, di-2-ethylhexyl, di-n-octyl, diisooctyl, diisononyl, diisodecyl, diisotridecyl and benzylbutyl phthalate and also the mentioned mixtures of alkyl phthalates.

Also suitable as plasticisers are the esters of aliphatic dicarboxylic acids, especially the esters of adipic, azelaic or sebacic acid or mixtures of two or more thereof. Examples of such plasticisers are di-2-ethylhexyl adipate, diisooctyl adipate, diisononyl adipate, diisodecyl adipate, benzylbutyl adipate, benzyloctyl adipate, di-2-ethylhexyl azelate, di-2-ethylhexyl sebacate and diisodecyl sebacate. Within the scope of a further embodiment of the present invention preference is given to di-2-ethylhexyl acetate and diisooctyl adipate.

Also suitable as plasticisers are trimellitic acid esters, such as tri-2-ethylhexyl trimellitate, triisotridecyl trimellitate, triisooctyl trimellitate and also trimellitic acid esters having from 6 to 8, 6 to 10, 7 to 9 or 9 to 11 carbon atoms in the ester group or mixtures of two or more of the mentioned compounds.

Suitable plasticisers are also, for example, polymer plasticisers, as mentioned in “Kunststoffadditive”, R. Gächter/H. Müller, Carl Hanser Verlag, 3rd edition, 1989, chapter 5.9.6, pages 412-415, or “PVC Technology”, W. V. Titow, 4th Edition, Elsevier Publishers, 1984, pages 165-170. The starting materials most commonly used for the preparation of polyester plasticisers are, for example, dicarboxylic acids, such as adipic, phthalic, azelaic or sebacic acid, and diols, such as 1,2-propanediol, 1,3-butanediol, 1,4-butanediol, 1,6-hexanediol, neopentyl glycol or diethylene glycol or mixtures of two or more thereof.

Also suitable as plasticisers are phosphoric acid esters, such as those in “Taschenbuch der Kunststoffadditive”, chapter 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethyl-hexyl-di-phenyl phosphate, triphenyl phosphate, tricresyl phosphate or trixylenyl phosphate, or mixtures of two or more thereof.

Also suitable as plasticisers are chlorinated hydrocarbons (paraffins) or hydrocarbons as described in “Kunststoffadditive”, R. Gächter/H. Müller, Carl Hanser Verlag, 3rd edition, 1989, chapter 5.9.14.2, pages 422-425, and chapter 5.9.14.1, page 422.

A stabiliser composition according to the invention can comprise the described plasticisers in an amount of up to approximately 99.5% by weight, especially up to approximately 30% by weight, up to approximately 20% by weight or up to approximately 10% by weight. Within the scope of a preferred embodiment of the present invention, the lower limit for the described plasticisers as constituent of the stabiliser compositions according to the invention is approximately 0.1% by weight or more, for example approximately 0.5% by weight, 1% by weight, 2% by weight or 5% by weight.

Pigments are also suitable as constituents of the stabiliser compositions according to the invention. Examples of suitable inorganic pigments are titanium dioxide, carbon black, Fe₂O₃, Sb₂O₃, (Ba, Sb)O₂, Cr₂O₃, spinels, such as cobalt blue and cobalt green, Cd (S, Se) or ultramarine blue. Suitable organic pigments are, for example, azo pigments, phthalocyanine pigments, quinacridone pigments, perylene pigments, diketopyrrolopyrrole pigments and anthraquinone pigments.

A stabiliser composition according to the invention can also comprise fillers, such as those described on pages 393 to 449 of “Handbook of PVC Formulating”, E. J. Wickson, John Wiley & Sons, Inc., 1993, or reinforcing agents, such as those described on pages 549 to 615 of “Taschenbuch der Kunststoffadditive”, R. Gätchter/H. Müller, Carl Hanser Verlag, 1990. Especially suitable fillers or reinforcing agents are, for example, calcium carbonate (chalk), dolomite, wollastonite, magnesium oxide, magnesium hydroxide, silicates, glass fibres, talc, kaolin, chalk, carbon black or graphite, wood flour or other renewable raw materials. Within the scope of a preferred embodiment of the present invention, a stabiliser composition according to the invention comprises chalk.

Within the scope of a further embodiment of the present invention, the stabiliser compositions according to the invention can comprise antioxidants, UV absorbers and light stabilisers or blowing agents. Suitable antioxidants are described, for example, on pages 33 to 35 of EP-A 1 046 668. Antioxidants preferred in the context of the present invention are the products of the Irganox® range (manufacturer: Ciba Specialty Chemicals), for example Irganox® 1010 or 1076 or products of Lowinox range from Great Lakes.

Suitable UV absorbers and light stabilisers are mentioned on pages 35 and 36 of EP-A 1 046 668. Reference is expressly made to both disclosures, the disclosures being regarded as part of this text.

Suitable blowing agents are, for example, organic azo and hydrazo compounds, tetrazoles, oxazines, isatoic anhydride, salts of citric acid, for example ammonium citrate, and also sodium carbonate and sodium hydrogen carbonate. Especially suitable are, for example, ammonium citrate, azodicarbonamide or sodium hydrogen carbonate or mixtures of two or more thereof.

A stabiliser composition according to the invention can also comprise impact strength modifiers and processing aids, gelling agents, antistatics, biocides, metal deactivators, optical brighteners, flame retardants and also antifogging compounds. Suitable compounds of those classes of compound are described, for example, in “Kunststoff Additive”, R. Keβler/H. Müller, Carl Hanser Verlag, 3rd edition, 1989 and also in “Handbook of PVC Formulating”, E. J. Wilson, J. Wiley & Sons, 1993.

The stabiliser compositions according to the invention are suitable for the stabilisation of halogen-containing polymers.

Examples of such halogen-containing polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, such as those already mentioned above, polymers of vinyl chloroacetate and dichlorodivinyl ether, chlorinated polymers of vinyl acetate, chlorinated polymeric esters of acrylic acid and α-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers. Within the scope of a preferred embodiment of the present invention, the stabiliser compositions according to the invention are used for the production of moulded articles of PVC-U, such as window profiles, industrial profiles, tubes and plates.

Also suitable for stabilisation with the stabiliser compositions according to the invention are the graft polymers of PVC with EVA, ABS or MBS. Preferred substrates for such graft copolymers are also the afore-mentioned homo- and co-polymers, especially mixtures of vinyl chloride homopolymers with other thermoplastic or elastomeric polymers, especially blends with ABS, MBS, NBR, SAN, EVA, CPE; MBAS, PAA (polyalkyl acrylate), PAMA (polyalkyl methacrylate), EPDM, polyamides or polylactones.

Likewise suitable for stabilisation with the stabiliser compositions according to the invention are mixtures of halogenated and non-halogenated polymers, for example mixtures of the above-mentioned non-halogenated polymers with PVC, especially mixtures of polyurethanes and PVC.

Furthermore, it is also possible for recyclates of chlorine-containing polymers to be stabilised with the stabiliser compositions according to the invention, in principle any recyclates of the above-mentioned halogenated polymers being suitable for this purpose. PVC recyclate, for example, is suitable in the context of the present invention.

The present invention therefore relates also to a polymer composition at least comprising a halogenated polymer and a stabiliser composition according to the invention.

Within the scope of a preferred embodiment of the present invention, a polymer composition according to the invention comprises the stabiliser composition according to the invention in an amount of from 0.1 to 20 phr, especially from approximately 0.5 to approximately 15 phr or from approximately 1 to approximately 12 phr. The unit phr represents “per hundred resin” and thus relates to parts by weight per 100 parts by weight of polymer.

A polymer composition according to the invention preferably comprises as halogenated polymer at least a proportion of PVC, the PVC content being especially at least approximately 20% by weight, preferably at least approximately 50% by weight, for example at least approximately 80% by weight or at least approximately 90% by weight.

The present invention relates also to a method of stabilising halogen-containing polymers in which a halogen-containing polymer or a mixture of two or more halogen-containing polymers or a mixture of one or more halogen-containing polymers and one or more halogen-free polymers is mixed with a stabiliser composition according to the invention.

The mixing together of polymer or polymers and the stabiliser composition according to the invention can in principle be effected at any time before or during the processing of the polymer. For example, the stabiliser composition can be mixed into the polymer, which is in powder or granule form, prior to processing. It is equally possible, however, to add the stabiliser composition to the polymer or polymers in the softened or molten state, for example during processing in an extruder, in the form of an emulsion or dispersion, in the form of a pasty mixture, in the form of a dry mixture or in the form of a solution or melt.

A polymer composition according to the invention can be brought into a desired form in known manner. Suitable methods are, for example, calendering, extrusion, injection-moulding, sintering, extrusion blowing or the plastisol process. A polymer composition according to the invention can also be used, for example, in the production of foamed materials. In principle, the polymer compositions according to the invention are suitable for the production of hard or soft PVC, especially for the production of PVC-U.

A polymer composition according to the invention can be processed to form moulded articles. The present invention therefore relates also to moulded articles, at least comprising a stabiliser composition according to the invention or a polymer composition according to the invention.

The term “moulded article” in the context of the present invention in principle includes any three-dimensional structures that can be produced from a polymer composition according to the invention. In the context of the present invention the term “moulded article” includes, for example, wire sheathings, automobile components, for example automobile components such as are used in the interior of the automobile, in the engine space or on the outer surfaces, cable insulators, decorative films, agricultural films, hoses, shaped sealing elements, office films, hollow bodies (bottles), packaging films, (deep-draw films), blown films, tubes, foamed materials, heavy duty profiles (window frames), light wall profiles, structural profiles, sidings, fittings, plates, foamed panels, co-extrudates having a recycled core, or housings for electrical apparatus or machinery, for example computers or household appliances.

Further examples of moulded articles that can be produced from a polymer composition according to the invention are synthetic leather, floor coverings, textile coatings, wallcoverings, coil coatings and underseals for motor vehicles.

The invention is explained in greater detail by the following examples.

### EXAMPLES

The formulations indicated in Table 1 below were prepared for the purpose of testing the effectiveness of the stabiliser compositions according to the invention. Formulations 4, 7 and 8 correspond to the compositions according to the invention, whereas formulations 1, 2, 3, 5 and 6 were tested for comparison purposes.

TABLE 1
Example formulations

| | No. | No. | No. | | No. | No. | | No. |
|---|---|---|---|---|---|---|---|---|
| Formulations | 1 | 2 | 3 | No. | 5 | 6 | No. | 8 |
| PVC | 100 | 100 | 100 | 100 | 100 | 100 | 100 | 100 |
| Chalk | 5 | 5 | 5 | 5 | 5 | 5 | 5 | 5 |
| Titanium dioxide | 3 | 3 | 3 | 3 | 3 | 3 | 3 | 3 |
| Baerorapid ® 10 F | 1 | 1 | 1 | 1 | 1 | 1 | 1 | 1 |
| Calcium hydroxide | 0.4 | 0.4 | 0.4 | 0.4 | 0.4 | 0.4 | 0.4 | 0.4 |
| Baerolub ® LTP | 0.15 | 0.15 | 0.15 | 0.15 | 0.15 | 0.15 | 0.15 | 0.15 |
| Baerolub ® PA | 0.5 | 0.5 | 0.5 | 0.5 | 0.5 | 0.5 | 0.5 | 0.5 |
| Antioxidant | 0.1 | 0.1 | 0.1 | 0.1 | 0.1 | 0.1 | 0.1 | 0.1 |
| Sodium perchlorate | | | | | 0.2 | 0.2 | 0.2 | 0.2 |
| (supported, 10%) | | | | | | | | |
| Butylene glycol | | 0.2 | | 0.2 | | 0.2 | | 0.2 |
| bis-3- | | | | | | | | |
| aminocrotonate | | | | | | | | |
| THEIC | | | 0.43 | 0.43 | | | 0.43 | 0.43 |

The dry blends prepared in accordance with the given formulations (formulations according to the invention shown in bold type) were processed to form sheets on a laboratory roller mechanism at 180° C. within a period of 3 minutes. The thermal stability of the resulting PVC test pieces was statically determined quantatively in the Congo red test according to DIN VDE 0472/T614 as well as qualitatively assessed visually in a Mathis oven (200° C., advance every 5 minutes). For determining the initial colour, the PVC sheet was processed further at 190° C. to form compressed panels. Their colour was measured using the CIE-LAB colour system. For determining the UV stability (sun test), test pieces of dimensions 19×19 mm were cut from the compressed panels and irradiated for 25, 50, 75, 100, 125, 150 and 175 hours with artificial light (765 W/m², 300-830 nm global radiation). A qualitative visual assessment of the ageing behaviour was made.

For weathering under thermal stress (red test), test pieces 19×19 mm were likewise irradiated for 1 hour with artificial light (765 W/m², 300-830 nm global radiation) and then tempered at 100° C. for 1 hour. In this case too, a qualitative visual assessment was then made (1=best score, 6=worst score).

The results of the tests can be seen in Table 2 below.

TABLE 2
Test results

| Formu- | HCl value | Behaviour in | L- | a- | b- | Sun | Red |
|---|---|---|---|---|---|---|---|
| lation | (minutes) | Mathis test | value | value | value | test | test |
| No. 1 | 7 | 5 | 73.6 | 10.5 | 6.5 | 5 | 5 |
| No. 2 | 7 | 4 | 82.2 | 7.2 | 9.6 | 4 | 4 |
| No. 3 | 13 | 3 | 93.7 | −0.6 | 13.9 | 2 | 2 |
| No. 4 | 14 | 3 | 94.6 | −1.2 | 10.2 | 2 | 1 |
| No. 5 | 12 | 5 | 86.6 | 7.8 | 18.3 | 5 | 5 |
| No. 6 | 13 | 4 | 91.5 | 2.4 | 14.9 | 3 | 4 |
| No. 7 | 20 | 2 | 94.2 | −1.4 | 13.4 | 2 | 2 |
| No. 8 | 21 | 1 | 94.6 | −1.4 | 9.3 | 1 | 1 |

The results indicated in bold type correspond to the examples according to the invention.

That which is claimed:

1. A stabiliser composition, comprising at least one amino alcohol, at least one halogen-containing salt of an oxy acid and at least one compound having a structural element of the general formula I: 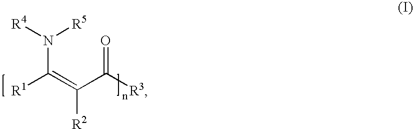
wherein n is a number from 1 to 100,000, the radicals R⁴, R⁵, R¹ and R² are each independently hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR⁴ or CH₂C(O), or the radical R³ is so linked to the radical R¹ that in total an unsubstituted or substituted, saturated or unsaturated heterocyclic ring system having from 4 to 24 carbon atoms is formed.

2. The stabiliser composition according to claim 1, further comprising at least one basic calcium salt.

3. The stabiliser composition according to claim 2, wherein the at least one basic calcium salt includes calcium hydroxide.

4. The stabiliser composition according to claim 1, further comprising at least one lubricant.

5. The stabiliser composition according to claim 1, wherein the at least one amino alcohol includes an isocyanurate.

6. The stabiliser composition according to claim 1, wherein said composition contains no zinc.

7. A moulded article, comprising the stabiliser composition according to claim 1.

8. A polymer composition, comprising:
a halogenated polymer; and
a stabiliser composition comprising at least one amino alcohol, at least one halogen-containing salt of an oxy acid and at least one compound having a structural element of the general formula I: 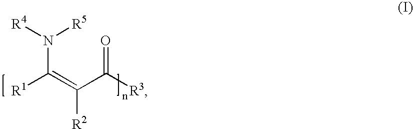
wherein n is a number from 1 to 100,000, the radicals R⁴, R⁵, R¹ and R² are each independently hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR⁴ or CH₂C(O), or the radical R³ is so linked to the radical R¹ that in total an unsubstituted or substituted, saturated or unsaturated heterocyclic ring system having from 4 to 24 carbon atoms is formed.

9. The polymer composition according to claim 8, wherein the stabiliser composition is present in an amount of from 0.1 to 15% by weight, based on the content of the halogenated polymer.

10. The polymer composition according to claim 8, wherein the stabiliser composition further comprises at least one basic calcium salt.

11. The polymer composition according to claim 10, wherein the at least one basic calcium salt in the stabiliser composition includes calcium hydroxide.

12. The polymer composition according to claim 8, wherein the stabiliser composition further comprises at least one lubricant.

13. The polymer composition according to claim 8, wherein the at least one amino alcohol in the stabiliser composition includes an isocyanurate.

14. The polymer composition according to claim 8, wherein the stabiliser composition contains no zinc.

15. A moulded article, comprising the polymer composition according to claim 7.

16. A method of stabilising a halogen-containing polymer, comprising mixing at least one halogen-containing polymer and optionally at least one halogen-free polymer with a stabiliser composition comprising at least one amino alcohol, at least one halogen-containing salt of an oxy acid and at least one compound having a structural element of the general formula I: 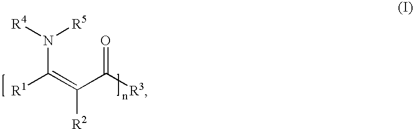
wherein n is a number from 1 to 100,000, the radicals R⁴, R⁵, R¹ and R² are each independently hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR⁴ or CH₂C(O), or the radical R³ is so linked to the radical R¹ that in total an unsubstituted or substituted, saturated or unsaturated heterocyclic ring system having from 4 to 24 carbon atoms is formed.

17. The method according to claim 16, wherein the stabiliser composition is present in an amount of from 0.1 to 15% by weight, based on the content of the at least one halogen-containing polymer.

18. The method according to claim 16, wherein the stabiliser composition further comprises at least one basic calcium salt.

19. The method according to claim 18, wherein the at least one basic calcium salt in the stabiliser composition includes calcium hydroxide.

20. The method according to claim 16, wherein the stabiliser composition further comprises at least one lubricant.

21. The method according to claim 16, wherein the at least one amino alcohol in the stabiliser composition includes an isocyanurate.

22. The method according to claim 16, wherein the stabiliser composition contains no zinc.
